(19) United States
(12) Patent Application Publication
(10) Pub. No.: US 2021/0354422 A1
(43) Pub. Date: Nov. 18, 2021

(54) DISPLAY SCREEN AND METHOD FOR MANUFACTURING THE SAME

(71) Applicant: WUHAN CHINA STAR OPTOELECTRONICS SEMICONDUCTOR DISPLAY TECHNOLOGY CO., LTD., Wuhan, Hubei (CN)

(72) Inventor: Jun CHEN, Wuhan, Hubei (CN)

(21) Appl. No.: 16/471,357

(22) PCT Filed: Apr. 1, 2019
(86) PCT No.: PCT/CN2019/080717

§ 371 Date: Jun. 19, 2019

(30) Foreign Application Priority Data
Dec. 21, 2018 (CN) 201811574177.7

(51) Int. Cl. B32B 7/022; B32B 3/16; B32B 37/18; B32B 38/00

(52) U.S. Cl. CPC B32B 7/022; B32B 3/16; B32B 37/18; B32B 2457/20; B32B 38/0036; B32B 2307/546; B32B 2307/54; B32B 38/0008

(57) ABSTRACT

The present invention provides a display screen and a method for manufacturing the same. The display screen includes a support film layer, including a first area film layer, a second area film layer and a third area film layer. The modulus of the second area film layer is smaller than that of the first and third area film layers. The flexible substrate includes a first area substrate, a second area substrate and a third area substrate, which are corresponding to the first, second and third area film layers, respectively.

### BACKGROUND OF THE INVENTION

### 1. Field of the Invention

The present invention relates to a display technology field, and more particularly to a display screen and a method for manufacturing the same.

### 2. Description of the Prior Art

With the continuous development of display technology, a flexible display screen become the focus of development, because of its bending characteristics and being capable of achieving narrow border.

Please refer to FIG. 1, a flexible display screen 1 includes a first support film layer 11, a filling layer 12, a function layer 13, a second support film layer 14, a flexible substrate 15, a touch control layer 16, a polarizer 17 and a flexible circuit board 18. Wherein, the flexible substrate 15 includes a first region 151, a second region 152 and a third region 153.

In the process of the flexible display screen 1, the first region 151 of the flexible substrate 15 is disposed on the second support film layer 14; the second region 152 of the flexible substrate 15 is bent and the third region 153 is disposed on one side of the first support film layer 11 away from the filling layer 12; and the flexible circuit board 18 is fixed on one side of the third region 153 away from the first support film layer 11.

However, the second region 152 of the flexible substrate 15 of the flexible display screen 1 has not be supported by any structure and is prone to collapse, resulting in damage to its circuits.

### BRIEF SUMMARY OF THE INVENTION

An object of the present invention is to provide a display screen and a method for manufacturing the same to improve the yield rate of the display screen.

The embodiment of the present invention provides a display screen, comprising:

a support film layer, including a first area film layer, a second area film layer and a third area film layer; the second area film layer being located between the first area film layer and the third area film layer; wherein, a modulus of the second area film layer is smaller than that of the first area film layer, and the modulus of the second area film layer is smaller than that of the third area film layer; and

a flexible substrate, including a first area substrate, a second area substrate and a third area substrate; the second area substrate being located between the first area substrate and the second area substrate; the first area substrate being disposed on the first area film layer; the second area substrate being bent and disposed on the second area film layer; and the third area substrate being disposed on the third area film layer.

In one embodiment, the display screen further includes a buffer layer, which is disposed on one side of the flexible substrate away from the support film layer.

In one embodiment, the modulus of the second area film layer is not greater than that of the buffer layer.

In one embodiment, the modulus of the second area film layer is between 0.1MPa and 800 MPa.

The embodiment of the present invention also provides a method for manufacturing a display screen, comprising steps of:

providing a support film layer, which includes a first area film layer, a second area film layer and a third area film layer; the second area film layer being located between the first area film layer and the third area film layer; wherein, a modulus of the second area film layer is smaller than that of the first and third area film layers; and

disposing a flexible substrate on the support film layer, the flexible substrate including a first area substrate, a second area substrate and a third area substrate; the first area substrate corresponding to the first area film layer; the second area substrate corresponding to the second area film layer; and the third area substrate corresponding to the third area film layer.

In one embodiment, before the step of providing the support film layer, the method further includes steps of:

dividing the support film layer into the first area film layer, the second area film layer and the third area film layer; and the second area film layer being located between the first area film layer and the third area film layer; and

reducing the modulus of the second area film layer, or increasing the modulus of the first area film layer and the third area film layer, for making the modulus of the second area film layer be smaller than that of the first and third area film layers.

In one embodiment, the step of reducing the modulus of the second area film layer, or increasing the modulus of the first area film layer and the third area film layer for making the modulus of the second area film layer be smaller than that of the first and third area film layers, includes:

treating the second area film layer by ultrasound, ultraviolet light, thermal energy or laser to reduce the modulus of the second area film layer; or treating the first and third area film layers by ultrasound, ultraviolet light, thermal energy or laser to increase the modulus of the first and third area film layers for making the modulus of the second area film layer be smaller than that of the first and third area film layers.

In one embodiment, after the step of disposing the flexible substrate on the support film layer, the method further includes: disposing a buffer layer on one side of the flexible substrate away from the support film layer.

In one embodiment, the modulus of the second area film layer is not greater than that of the buffer layer.

In one embodiment, the modulus of the second area film layer is between 0.1 MPa and 800 MPa.

The embodiment of the present invention further provides a method for manufacturing a display screen, comprising steps of:

providing a support film layer;

disposing a flexible substrate on the support film layer, the flexible substrate including a first area substrate, a second area substrate and a third area substrate; the second area substrate being located between the first and third area substrates;

dividing the support film layer into a first area film layer, a second area film layer and a third area film layer; wherein, the first area film layer corresponding to the first area substrate; the second area film layer corresponding to the second area substrate; and the third area film layer corresponds to the third area substrate; and

treating the support film layer to make a modulus of the second area film layer be smaller than that of the first and third area film layers.

In one embodiment, the step of treating the support film layer to make a modulus of the second area film layer smaller than that of the first and third area film layers, includes:

treating the second area film layer by ultrasound, ultraviolet light, thermal energy or laser to reduce the modulus of the second area film layer, or treating the first and third area film layers by ultrasound, ultraviolet light, thermal energy or laser to increase the modulus of the first and third area film layers, for making the modulus of the second area film layer be smaller than that of the first and third area film layers.

In one embodiment, after the step of treating the support film layer to make a modulus of the second area film layer smaller than that of the first and third area film layers, the method further includes: disposing a buffer layer on one side of the flexible substrate away from the support film layer.

In one embodiment, the modulus of the second area film layer is not greater than that of the buffer layer.

In one embodiment, the modulus of the second area film layer is between 0.1 MPa and 800 MPa.

The display screen and the method for manufacturing the display screen in the embodiment of the present invention provides the support film layer, which includes the first, second and third area film layers, to support the flexible substrate. Further, the modulus of the second area film layer is set to be smaller than that of the first and third area film layers, thereby efficiently supporting the flexible substrate and improving the yield rate of the display screen.

### BRIEF DESCRIPTION OF THE DRAWINGS

For more clearly understanding the above-mentioned contents of the present invention, the preferred embodiments are hereinafter described in detail in conjunction with the accompanying schematics as follows.

FIG. 1 is a schematic view of a prior display screen;

FIG. 2 is a schematic view showing a display screen of one embodiment of the present invention;

FIG. 3 is a schematic view more specifically showing the display screen of the embodiment of the present invention;

FIG. 4 is a flow chart of a method for manufacturing the display screen provided in one embodiment of the present invention;

FIG. 5 is a first scene schematic view of the method for manufacturing the display screen provided in the embodiment of the present invention;

FIG. 6 is a second scene schematic view of the method for manufacturing the display screen provided in the embodiment of the present invention;

FIG. 7 is another flow chart of the method for manufacturing the display screen provided in one embodiment of the present invention;

FIG. 8 is a third scene schematic view of the method for manufacturing the display screen provided in the embodiment of the present invention; and

FIG. 9 is a fourth scene schematic view of the method for manufacturing the display screen provided in the embodiment of the present invention.

### DETAILED DESCRIPTION OF THE PREFERRED EMBODIMENTS

The following description of every embodiment with reference to the accompanying drawings is used to exemplify a specific embodiment, which may be carried out in the present invention. Directional terms mentioned in the present invention, such as “top”, “bottom”, “front”, “back”, “left”, “right”, “inner”, “outer”, “side” etc., are only used with reference to the orientation of the accompanying drawings. Therefore, the used directional terms are intended to illustrate, but not to limit, the present invention.

In the figures, units with similar structures are represented by the same label.

The embodiment mentioned in the text means that the specific features, structures or characteristics described in connection with embodiments may be included in at least one embodiment of the invention. The embodiment appearing at various locations in the specification does not necessarily refer to the same embodiment, nor is it an independent or alternative embodiment that is mutually exclusive from other embodiments. It can be explicitly and implicitly understood by those skilled in the art that the embodiment described herein may be combined with other embodiments.

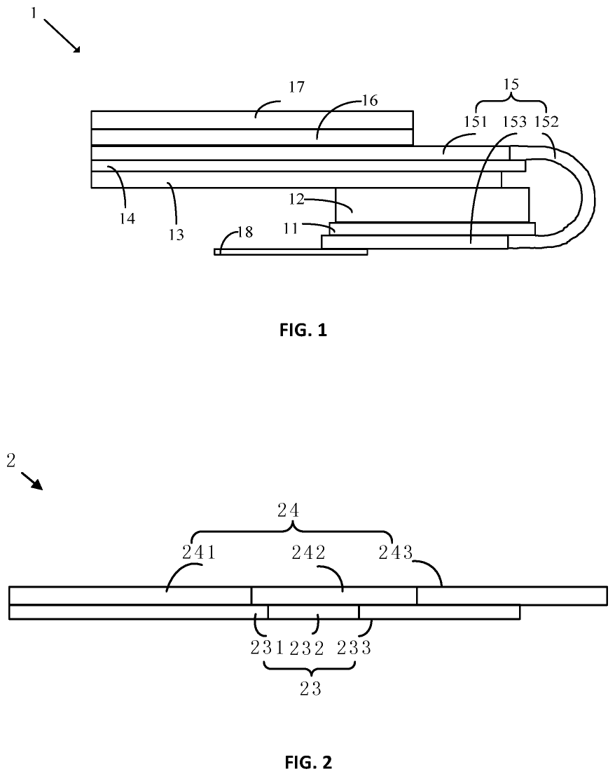

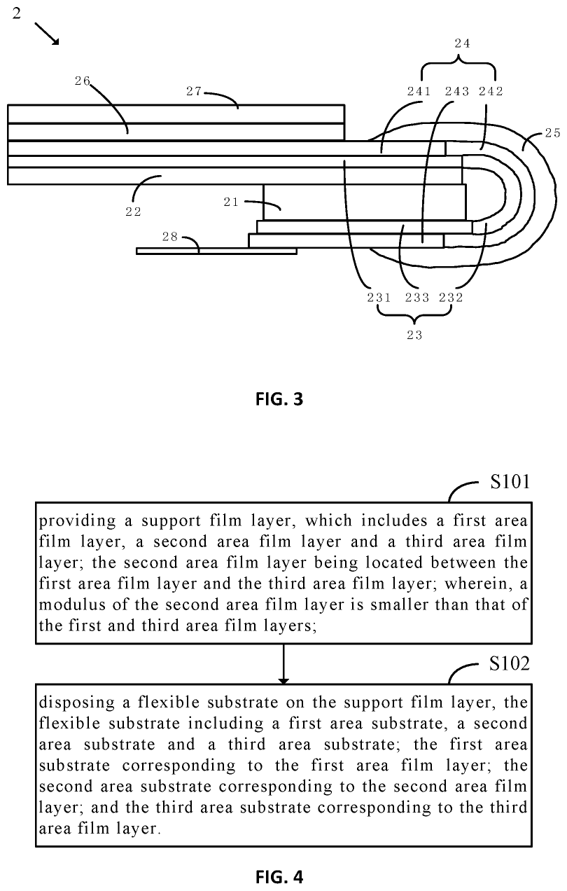

Please refer to FIG. 2, FIG. 2 is a schematic view showing a display screen of one embodiment of the present invention. The display screen 2 includes a support film layer 23 and a flexible substrate 24. In one embodiment, referring to FIG. 3, the display screen 2 further includes a filling layer 21, a function layer 22, a buffer layer 25, a touch control layer 26, a polarizer 27 and a flexible circuit board 28, etc.

The flexible substrate 24 includes a first area substrate 241, a second area substrate 242 and a third area substrate 243. Wherein, the first area substrate 241 acts as a substrate located in a display area of the display screen 2. The second area substrate 242 is a substrate in a bending area of the display screen 2, and is located between the first area substrate 241 and the third area substrate 243. The third area substrate 243 is a substrate in a bonding area of the display screen 2.

The touch control layer 26 is disposed on the first area substrate 241 and is used for touch control. The polarizer 27 is disposed on the touch control layer 26 and is used for light filtering. The flexible circuit board 28 integrates multiple control circuits, which are bonded to the third area substrate 243.

The support film layer 23 includes a first area film layer 231, a second area film layer 232 and a third area film layer 233. The second area film layer 232 is located between the first and third area film layers 231, 233.

Referring to FIG. 3, the first area film layer 231 is used to support the flexible substrate 24, the touch control layer 26, the polarizer 27 and other main structures thereon. The second area film layer 232 can be bent. The third area film layer 233 is used to support the flexible circuit board 28 thereon.

In one embodiment, a modulus of the second area film layer 232 is set to be smaller than that of the first area film layer 231, and is also set to be smaller than that of the third area film layer 233. Namely, the second area film layer 232 has a better deformation property, and at the same time, it can form an effective supporting structure. In one embodiment, the modulus of the second area film layer 232 is set between 0.1 MPa and 800 MPa.

The first area substrate 241 is disposed on the first area film layer 231. The second area substrate 242 is bent on the second area film layer 232, so that the second area substrate 242 can be supported by the second area film layer 232. Further, because the modulus of the second area film layer 232 is smaller, the second area film layer 232 can support the second area substrate 242 better. The third area substrate 243 is disposed on the third area film layer 232.

The function layer 22 is disposed on one side of the first area film layer 231 away from the flexible substrate 24. The function layer 22 integrates the functions of electronic shielding, heat dissipation and supporting display screen. The filling layer 21 is disposed on one side of the function layer 22 away from the support film layer 23. The filling layer 21 can fill the gap in the display screen 2 and support the display screen 2.

In one embodiment, the first area film layer 231 may be disposed on the function layer 22. The second area film layer 232 is bent downward, to make the third area film layer 233 be disposed on one side of the filling layer 21 away from the function layer 22.

In one embodiment, the third area film layer 233 can also be disposed on one side of the filling layer 21 away from the function layer 22, and then the second area film layer 232 is bent upward to make the first area film layer 231 be disposed on the function layer 22.

The buffer layer 25 is disposed on one side of the flexible substrate 24 away from the support film layer 23. The buffer layer 25 not only can support and protect the flexible substrate 24 when the flexible substrate 24 is bent, but also can adjust middle layers of the display screen 2. Further, the buffer layer 25 may share the stress when the display screen 2 is stressed, so as to avoid damage to the second area substrate 242.

In one embodiment, the modulus of the second area film layer 232 is not greater than that of the buffer layer 25. The second area film layer 232 and the buffer layer 25 can cooperate with each other to protect the second area film layer 232.

In one embodiment, the modulus of the buffer layer on the second area substrate 242 is smaller than that of the buffer layer on the first and third area substrates 242, 243, so the buffer layer on the second area substrate 242 can share stress better.

In the embodiment of the present invention, the display screen disposes the support film layer, including the first area film layer, the second area film layer and the third area film layer, to support the flexible substrate. Further, the modulus of the second area film layer is set to be smaller than that of the first and third area film layers, thereby efficiently supporting the flexible substrate and improving the yield rate of the display screen.

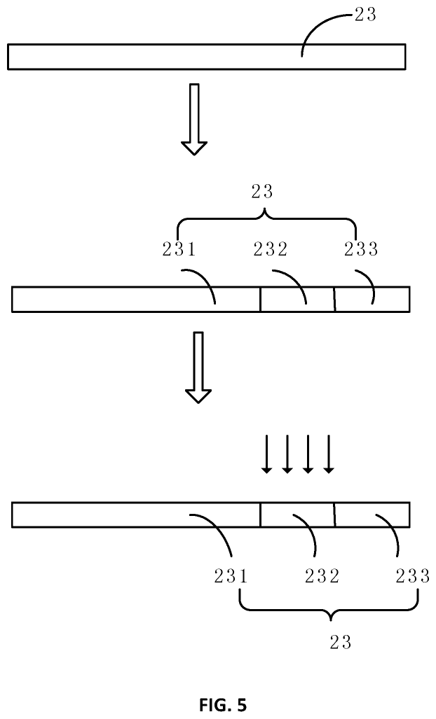

Please refer to FIG. 4, FIG. 4 is a flow chart of a method for manufacturing the display screen provided in one embodiment of the present invention. The method for manufacturing the display screen includes: a step S101 and a step S102.

The step S101 is providing a support film layer. The support film layer includes a first area film layer, a second area film layer and a third area film layer. The second area film layer is located between the first and third area film layers. Wherein, the modulus of the second area film layer is smaller than that of the first and third area film layers.

Referring to FIG. 3, the support film layer 23 includes the first area film layer 231, the second area film layer 232 and the third area film layer 233. The second area film layer 232 is located between the first and third area film layers 231, 233.

Referring to FIG. 5, before providing the support film layer 23, the support film layer 23 needs to be divided into the first area film layer 231, the second area film layer 232 and the third area film layer 233 in turn; and the modulus of the second area film layer 232 is reduced to be smaller than that of the first and third area film layers 231, 233. In one embodiment, ultrasound, ultraviolet light, thermal energy or laser can be used to treat the second area film layer 232 for reducing the modulus of the second area film layer 232.

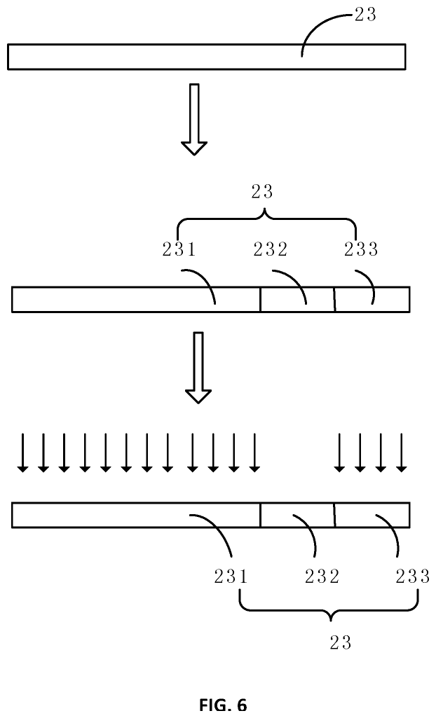

Referring to FIG. 6, the modulus of the first and third area film layers 231, 233 can be increased, thereby making the modulus of the second area film layer 232 is smaller than that of the first and third area film layers 231, 233. In one embodiment, ultrasound, ultraviolet light, thermal energy or laser can be used to treat the first and third area film layers 231, 233 for increasing the modulus thereof, thereby making the modulus of the second area film layer 232 be smaller than that of the first and third area film layers 231, 233.

The support film layer 23 has a support function. The second area film layer 232 can form a more efficient support structure because the modulus of the second area film layer 232 is smaller than that of the first and third area film layers 231, 233. In one embodiment, the modulus of the second area film layer 232 can be set between 0.1 MPa and 800 MPa.

The step S102 is disposing a flexible substrate on the support film layer. The flexible substrate includes a first area substrate, a second area substrate and a third area substrate. Wherein the first area substrate is corresponding to the first area film layer, the second area substrate is corresponding to the second area film layer, and the third area substrate is corresponding to the third area film layer.

Referring to FIG. 3, the flexible substrate 24 includes the first area substrate 241, the second area substrate 242 and the third area substrate 243. When the flexible substrate 24 is disposed on the support film layer 23, the first area substrate 241 is correspondingly attached to the first area film layer 231, the second area substrate 242 is correspondingly attached to the second area film layer 232, and the third area substrate 243 is correspondingly attached to the third area film layer 233.

After the flexible substrate 24 is attached to the support film layer 23, the buffer layer 25 can be disposed on one side of the flexible substrate 24 away from the support film layer 23. The buffer layer 25 can share the stress when the display screen 2 is stressed, so as to avoid damage to the second area substrate 242. In one embodiment, the modulus of the second area film layer 232 is not greater than that of the buffer layer 25, and the both can cooperate with each other to protect the second area film layer 232. In one embodiment, the modulus of the buffer layer on the second area substrate 242 is smaller than that of the buffer layer on the first and third area substrates 241, 243, so that the buffer layer on the second area film layer 232 can share stress better.

In one embodiment, the first area substrate 241 further disposes the touch control layer 26, which is used to realize touch control. The touch control layer 26 disposes the polarizer 27 thereon. The polarizer 27 is used for light filtering. The flexible circuit board 28 is bonded on one side of the third area substrate 243 away from the third area film layer 233.

In one embodiment, there disposes the function layer 22 on one side of the first area film layer 231 away from the flexible substrate 24. The function layer 22 integrates the functions of electronic shielding, heat dissipation and supporting display screen. There disposes the filling layer 21 on one side of the function layer 22 away from the support film layer 23. The filling layer 21 can fill the gap in the display screen 2 and support the display screen 2.

If there is no buffer layer 25, the second area substrate 242 and the second area film layer 232 can be bent, and the third area film layer 233 can be located on one side of the filling layer 21 away from the function layer 22.

If there is the buffer layer 25, the second area substrate 242, the second area film layer 232 and the buffer layer 25 can be bent, and the third area film layer 233 can be located on one side of the filling layer 21 away from the function layer 22.

In the embodiment of the present invention, the method for manufacturing the display screen provides the support film layer including the first, second and third area film layers to support the flexible substrate. Further, the modulus of the second area film layer is set to be smaller than that of the first and third area film layers, thereby efficiently supporting the flexible substrate and improving the yield rate of the display screen.

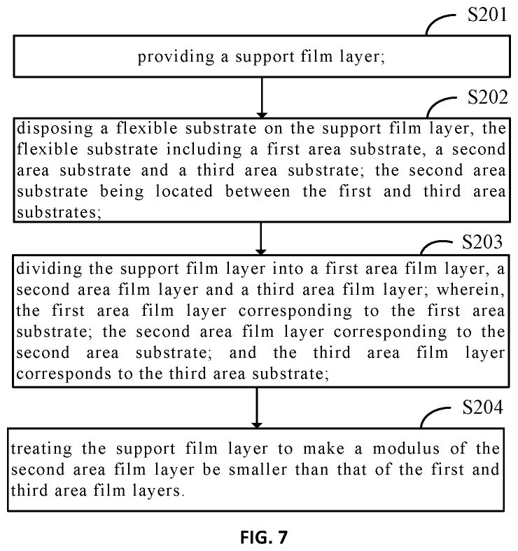

Please refer to FIG. 7, FIG. 7 is another flow chart of the method for manufacturing the display screen provided in one embodiment of the present invention. The method for manufacturing the display screen includes the following steps S201-S204.

The step 5201 is providing a support film layer.

The support film layer provides a support function. Specifically, the support film layer is adhered to a function layer 22 by an optical clear adhesive (OCA). Wherein, the function layer 22 integrates the functions of electronic shielding, heat dissipation and supporting display screen, etc.

The step 5202 is disposing a flexible substrate on the support film layer. The flexible substrate includes a first area substrate, a second area substrate and a third area substrate. Wherein, the second area substrate is located between the first and third area substrates.

Referring to FIG. 3, the flexible substrate 24 includes the first area substrate 241, the second area substrate 242 and the third area substrate 243. Wherein, the first area substrate 241 is a substrate located in a display area of the display screen 2. The second area substrate 242 is a substrate in a bending area of the display screen 2. The third area substrate 243 is a substrate in a bonding area of the display screen 2.

The step S203 is dividing the support film layer into a first area film layer, a second area film layer and a third area film layer. Wherein the first area film layer corresponds to the first area substrate, the second area film layer corresponds to the second area substrate, and the third area film layer corresponds to the third area substrate.

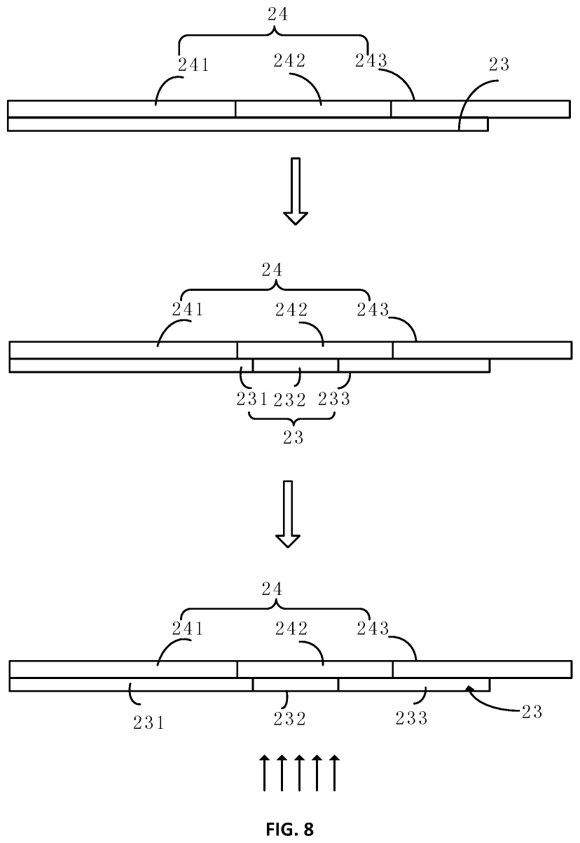

Referring to FIG. 8, the support film layer 23 can be divided into the first area film layer 231 corresponding to the first area substrate 241, the second area film layer 232 corresponding to the second area substrate 242, and the third area film layer 233 corresponding to the third area substrate 243. The support film layer 23 is first fit to the flexible substrate 24, and then the support film layer 23 is divided into three parts, whereby the alignment error of division before fitting can be avoided.

The step S204 is treating the support film layer to make the modulus of the second area film layer be smaller than that of the first and third area film layers.

In one embodiment, the modulus of the second area film layer 232 is reduced to be smaller than that of the first and third area film layers 231, 233. Referring to FIG. 8, the second area film layer 232 can be treated by ultrasound, ultraviolet light, thermal energy or laser for reducing the modulus of the second area film layer 232.

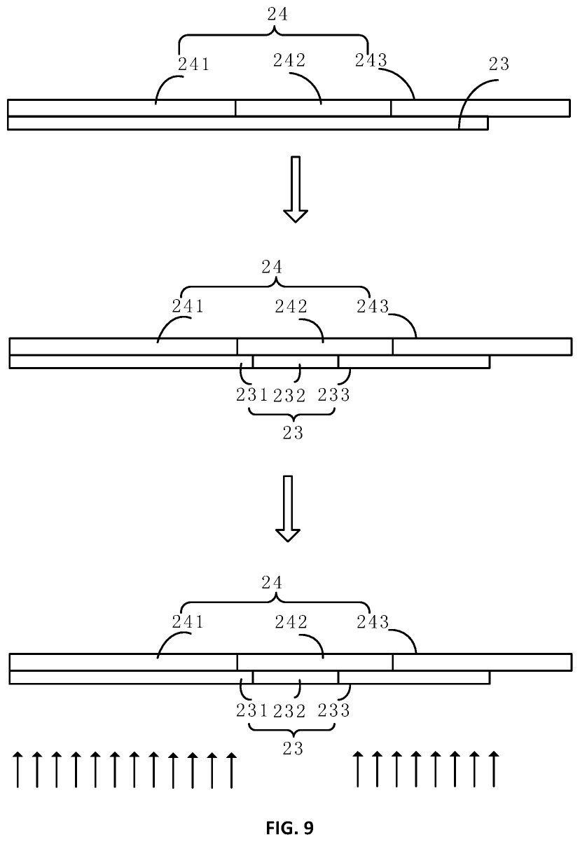

In one embodiment, the modulus of the first and third area film layers 231, 233 can be increased to make the modulus of the second area film layer 232 be smaller than that of the first and third area film layers 231, 233. Referring to FIG. 9, the first and third area film layers 231, 233 can be treated by ultrasound, ultraviolet light, thermal energy or laser for increasing the modulus thereof and making the modulus of the second area film layer 232 be smaller than that of the first and third area film layers 231, 233.

The above support film layer 23 has a support function. The second area film layer 232 can form a more efficient support structure because the modulus of the second area film layer 232 is smaller than that of the first and third area film layers 231, 233. In one embodiment, the modulus of the second area film layer 232 can be set between 0.1 MPa and 800 MPa.

There is a buffer layer 25 disposed on one side of the flexible substrate 24 away from the support film layer 23. The buffer layer 25 not only can support and protect the flexible substrate 24 when the flexible substrate 24 is bent, but also can adjust middle layers of the display screen 2. Further, the buffer layer 25 may share the stress when the display screen 2 is stressed, thereby avoiding damage to the second area substrate 242.

In one embodiment, the modulus of the second area film layer 232 is not greater than that of the buffer layer 25, and the both can cooperate with each other to protect the second area film layer 232. In one embodiment, the modulus of the buffer layer on the second area substrate 242 is smaller than that of the buffer layer on the first and third area substrates 241, 243, so that the buffer layer on the second area film layer 232 can share stress better.

Next, there is a filling layer 21 disposed on one side of the function layer 22 away from the support film layer 23. The filling layer 21 can fill the gap in the display screen 2 and support the display screen 2.

If there is no buffer layer 25, the second area substrate 242 and the second area film layer 232 can be bent, and the third area film layer 233 can be located on one side of the filling layer 21 away from the function layer 22.

If there is the buffer layer 25, the second area substrate 242, the second area film layer 232 and the buffer layer 25 can be bent, and the third area film layer 233 can be located on one side of the filling layer 21 away from the function layer 22.

In the embodiment, of the present invention, the method for manufacturing the display screen is first combining the support film layer and the flexible substrate, and then dividing the support film layer into the first, second and third area film layers according to the first, second and third area substrate, thereby avoiding the fitting error, being capable of supporting the flexible substrate better, and improving the yield rate of the display screen.

As described above, although the present invention has been disclosed as described above in preferred embodiments, the preferred embodiments described above are not intended to limit the present invention. It should be pointed out that any person having ordinary skills in the art also can make many improvement and amendment within the principles of the present invention. Consequently, the scope of protection of the present invention shall be defined by the claims.

What is claimed is:

1. A display screen, comprising:
a support film layer, including a first area film layer, a second area film layer and a third area film layer; the second area film layer being located between the first area film layer and the third area film layer; wherein, a modulus of the second area film layer is smaller than that of the first area film layer, and the modulus of the second area film layer is smaller than that of the third area film layer; and
a flexible substrate, including a first area substrate, a second area substrate and a third area substrate; the second area substrate being located between the first area substrate and the second area substrate; the first area substrate being disposed on the first area film layer; the second area substrate being bent and disposed on the second area film layer; and the third area substrate being disposed on the third area film layer.

2. The display screen as claimed in claim 1, wherein the display screen further includes a buffer layer, which is disposed on one side of the flexible substrate away from the support film layer.

3. The display screen as claimed in claim 2, wherein the modulus of the second area film layer is not greater than that of the buffer layer.

4. The display screen as claimed in claim 1, wherein the modulus of the second area film layer is between 0.1 MPa and 800 MPa.

5. A method for manufacturing a display screen, comprising steps of:
providing a support film layer, which includes a first area film layer, a second area film layer and a third area film layer; the second area film layer being located between the first area film layer and the third area film layer; wherein, a modulus of the second area film layer is smaller than that of the first and third area film layers; and
disposing a flexible substrate on the support film layer, the flexible substrate including a first area substrate, a second area substrate and a third area substrate; the first area substrate corresponding to the first area film layer; the second area substrate corresponding to the second area film layer; and the third area substrate corresponding to the third area film layer.

6. The method for manufacturing the display screen as claimed in claim 5, wherein before the step of providing the support film layer, which includes the first area film layer, the second area film layer and the third area film layer; the second area film layer being located between the first area film layer and the third area film layer; wherein, the modulus of the second area film layer is smaller than that of the first and third area film layers;
the method further includes steps of:
dividing the support film layer into the first area film layer, the second area film layer and the third area film layer; and the second area film layer being located between the first area film layer and the third area film layer; and
reducing the modulus of the second area film layer, or increasing the modulus of the first area film layer and the third area film layer, for making the modulus of the second area film layer be smaller than that of the first and third area film layers.

7. The method for manufacturing the display screen as claimed in claim 6, wherein the step of reducing the modulus of the second area film layer, or increasing the modulus of the first area film layer and the third area film layer for making the modulus of the second area film layer be smaller than that of the first and third area film layers, includes:
treating the second area film layer by ultrasound, ultraviolet light, thermal energy or laser to reduce the modulus of the second area film layer; or treating the first and third area film layers by ultrasound, ultraviolet light, thermal energy or laser to increase the modulus of the first and third area film layers for making the modulus of the second area film layer be smaller than that of the first and third area film layers.

8. The method for manufacturing the display screen as claimed in claim 5, wherein after the step of disposing the flexible substrate on the support film layer, the flexible substrate including the first area substrate, the second area substrate and the third area substrate; the first area substrate corresponding to the first area film layer; the second area substrate corresponding to the second area film layer; and the third area substrate corresponding to the third area film layer;
the method further includes:
disposing a buffer layer on one side of the flexible substrate away from the support film layer.

9. The method for manufacturing the display screen as claimed in claim 8, wherein the modulus of the second area film layer is not greater than that of the buffer layer.

10. The method for manufacturing the display screen as claimed in claim 5, wherein the modulus of the second area film layer is between 0.1 MPa and 800 MPa.

11. A method for manufacturing a display screen, comprising steps of:
providing a support film layer;
disposing a flexible substrate on the support film layer, the flexible substrate including a first area substrate, a second area substrate and a third area substrate; the second area substrate being located between the first and third area substrates;
dividing the support film layer into a first area film layer, a second area film layer and a third area film layer; wherein, the first area film layer corresponding to the first area substrate; the second area film layer corresponding to the second area substrate; and the third area film layer corresponds to the third area substrate; and
treating the support film layer to make a modulus of the second area film layer be smaller than that of the first and third area film layers.

12. The method for manufacturing the display screen as claimed in claim 11, wherein the step of treating the support film layer to make a modulus of the second area film layer smaller than that of the first and third area film layers, includes:
treating the second area film layer by ultrasound, ultraviolet light, thermal energy or laser to reduce the modulus of the second area film layer, or treating the first and third area film layers by ultrasound, ultraviolet light, thermal energy or laser to increase the modulus of the first and third area film layers, for making the modulus of the second area film layer be smaller than that of the first and third area film layers.

13. The method for manufacturing the display screen as claimed in claim 11, wherein after the step of treating the support film layer to make a modulus of the second area film layer be smaller than that of the first and third area film layers, the method further includes:
disposing a buffer layer on one side of the flexible substrate away from the support film layer.

14. The method for manufacturing the display screen as claimed in claim 11, wherein the modulus of the second area film layer is not greater than that of the buffer layer.

15. The method for manufacturing the display screen as claimed in claim 11, wherein the modulus of the second area film layer is between 0.1 MPa and 800 MPa.
